(19) United States
(12) Patent Application Publication
(10) Pub. No.: US 2006/0186824 A1
(43) Pub. Date: Aug. 24, 2006

(54) Pixel array and fabrication method thereof

(75) Inventor: Wein-Town Sun, Longtan Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/352,792

(22) Filed: Feb. 13, 2006

(30) Foreign Application Priority Data
Feb. 24, 2005 (TW) 94105548

(51) Int. Cl. G09G 3/10

(52) U.S. Cl. 315/169.3

(57) ABSTRACT

A pixel array comprising a plurality of pixel driving circuits for an electroluminescent device. Each pixel driving circuit comprises a switch transistor, a scan line, a data line, a driving transistor, an electroluminescent device, a storage capacitor and a compensation capacitor. The scan and data lines are respectively connected to first and second terminals of the switch transistor. First and second terminals of the driving transistor are respectively connected to a third terminal of the switch transistor and a first potential. The electroluminescent device is connected between a third terminal of the driving transistor and a second potential. The storage capacitor is connected between the first terminal of the driving transistor and the first potential, or a previous scan line. The compensation capacitor is connected between the first terminals of the switching and driving transistors. Not all compensation capacitors connected to the same scan line have the same capacitance.

### BACKGROUND OF THE INVENTION

1. Field of the Invention

The invention relates to an electroluminescent device (EL device) and, in particular, to an electroluminescent pixel array and fabrication method thereof.

2. Description of the Related Art

Since brightness of an organic light emitting diode (OLED) is proportional to current conducted thereby, current variation directly influences display uniformity thereof. In FIG. 1, in a conventional voltage-driven pixel, when a voltage is written in A point as image data, a current of a driving transistor T_{dr} is changed accordingly. The current flows through the organic light emitting diode OLED and induces a light proportional to the voltage. When the switch transistor T_{sw} is turned off by the scan line SL, signal transition thereon induces a coupling voltage due to a parasitic capacitor C_{gs} between a gate and a source of the switch transistor T_{sw} and a voltage stored at node A is changed; Thus, a reproducing current through the OLED after the scan line is turned off is changed, as is brightness of the pixel.

The same occurs in current-driven pixels, as shown in FIGS. 2 and 3. Solid lines in FIGS. 2 and 3 show paths of data current Idata in a write stage, and dashed lines paths of reproducing current in a reproducing stage. In the current-driven pixels, when the data current Idata flows through a driving transistor T3 during a write stage, a voltage corresponding to the data current Idata is stored in a storage capacitor Cₛ between a source and a gate of the driving transistor T3 such that voltage required to provide the data current. Idata is maintained. When a signal on the scan line (or erase scan line) is switched to turn off a switch transistor T2, a small signal is coupled to the node A through the capacitor C_{gs} of the switch transistor and a voltage across the storage capacitor Cₛ is changed. Thus, the reproducing current during the reproducing stage is changed, as is brightness of the pixel.

Variations in pixel voltage due to feedthrough effect result in different brightness of OLEDs on the same row. If voltage conditions of the pixels on the same row are the same, this is not a concern. Resistance of the scan lines and parasitic capacitances, however, results in RC delays of signals on the scan lines. FIG. 4 is a schematic diagram of a pixel array. FIG. 5A is a schematic diagram of pixel driving circuits on a scan line in the pixel array of FIG. 4. As shown in FIG. 5B, when a scan signal is input from the left side, a first pixel on the left side registers an almost ideal square wave. The scan signal gradually distorts due to RC delay. The scan signal distorts most significantly at the right side of the scan line and rising and falling times thereof increase. Thus, a pixel voltage Vpixel of the pixel on the left side of the pixel array drops due to turn-off of the switch transistor due to switching of the scan signal and coupling of a small signal to the pixel. The switch transistor in the pixel on the right side of the pixel array does not turn off immediately after the scan signal switches. As a result, voltage of the pixel on the right side exceeds that on the left side, becoming more serious with increased panel size.

### BRIEF SUMMARY OF THE INVENTION

An embodiment of a pixel array comprises a plurality of pixel driving circuits for an electroluminescent device. Each pixel driving circuit comprises a switch transistor, a scan line, a data line, a driving transistor, an electroluminescent device, a storage capacitor and a compensation capacitor. The scan and data lines are respectively connected to first and second terminals of the switch transistor. First and second terminals of the driving transistor are respectively connected to a third terminal of the switch transistor and a first potential. The electroluminescent device is connected between a third terminal of the driving transistor and a second potential. The storage capacitor is connected between the first terminal of the driving transistor and the first potential, or a previous scan line. The compensation capacitor is connected between the first terminals of the switch and driving transistors. Not all compensation capacitors connected to the same scan line have the same capacitance.

An embodiment of a method of fabricating a pixel array, wherein pixels therein are current-driven, comprises forming a plurality of pixel driving circuits for an electroluminescent device and forming a compensation capacitor in each pixel driving circuit. Each pixel driving circuit comprises a switch transistor, a scan line, a data line, a driving transistor, an electroluminescent device, and a storage capacitor. The scan and data lines are respectively connected to first and second terminals of the switch transistor. First and second terminals of the driving transistor are respectively connected to a third terminal of the switch transistor and a first potential. The electroluminescent device is connected between a third terminal of the driving transistor and a second potential. The storage capacitor is connected between the first terminal of the driving transistor and the first potential, or a previous scan line. The compensation capacitor is connected between the first terminals of the switch and driving transistors. Not all of the compensation capacitors connected to the same scan line have the same capacitance.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a circuit diagram of a pixel driving circuit of a conventional electroluminescent device;

FIGS. 2 and 3 are other circuit diagrams of a pixel driving circuit of a conventional electroluminescent device;

FIG. 4 is a schematic diagram of a pixel array;

FIG. 5A is a schematic diagram of pixel driving circuits on a scan line in the pixel array of FIG. 4;

FIG. 5B is a schematic diagram showing variation of scan signal and pixel voltage with pixel location;

FIG. 6 is a schematic diagram of pixel driving circuits on the same row in a pixel array according to an embodiment of the invention;

FIG. 7A is a circuit diagram of a conventional pixel driving circuit used in simulation;

FIG. 7B is a circuit diagram of a pixel driving circuit according to an embodiment of the invention used in simulation;

FIG. 8A is a simulation diagram showing scan voltage on the scan line of the conventional pixel driving circuit in FIG. 7A;

FIG. 8B is a simulation diagram showing pixel voltage of the conventional pixel driving circuit in FIG. 7A;

FIG. 9A is a simulation diagram showing scan voltage on the scan line of the conventional pixel driving circuit in FIG. 7B;

FIG. 9B is a simulation diagram showing pixel voltage of the conventional pixel driving circuit in FIG. 7B;

FIG. 10 is a circuit diagram of a pixel driving circuit in a pixel array according to another embodiment of the invention.

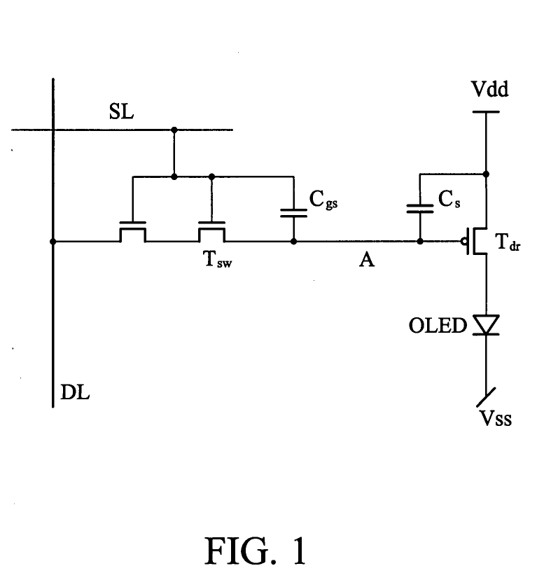

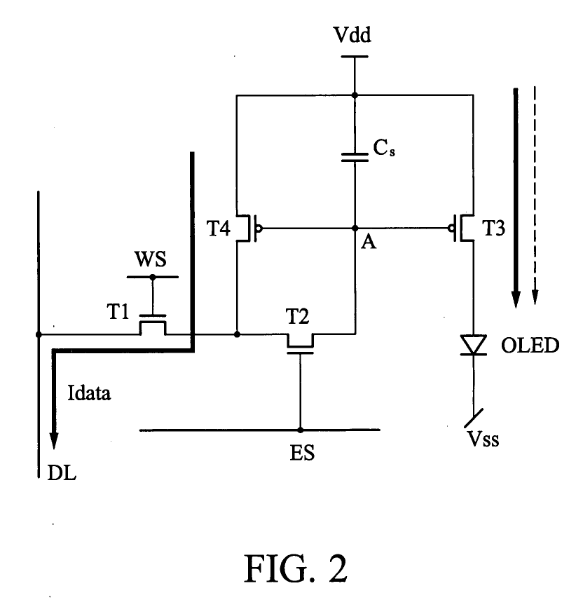

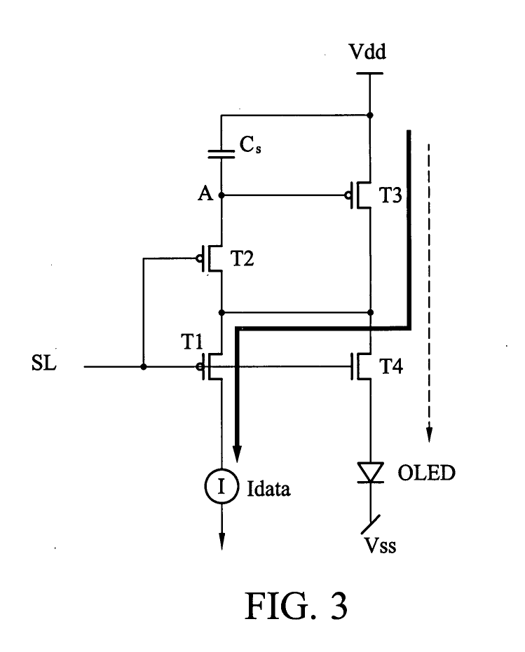

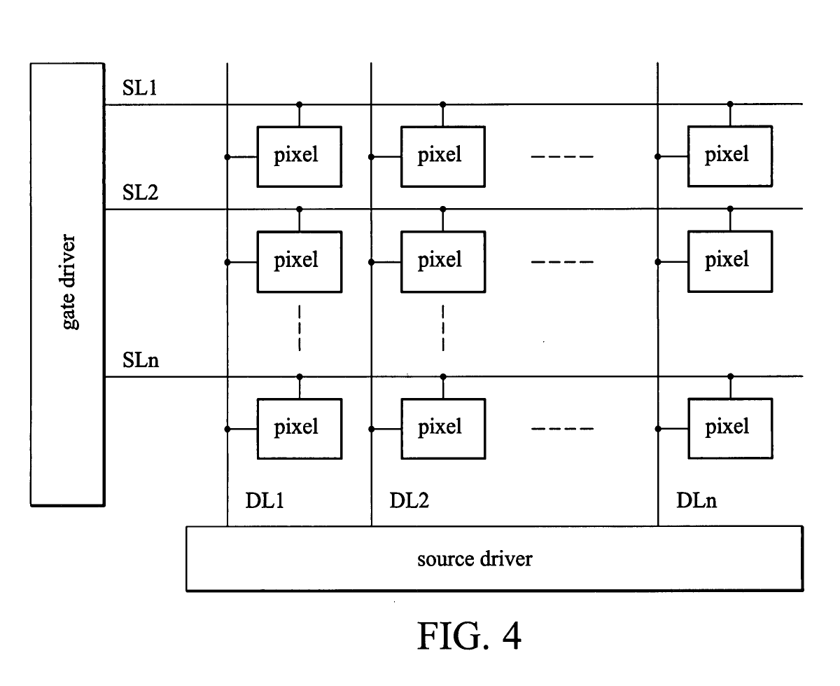

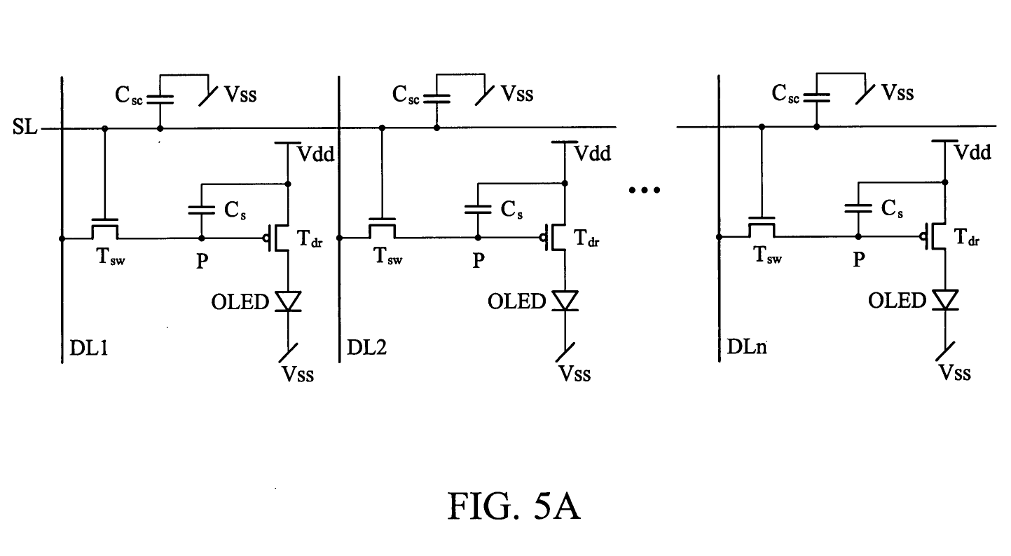

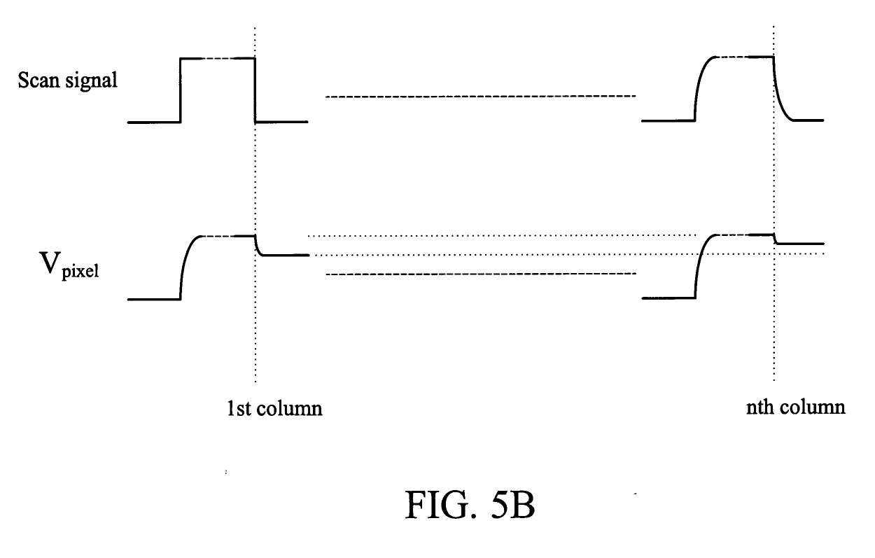

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

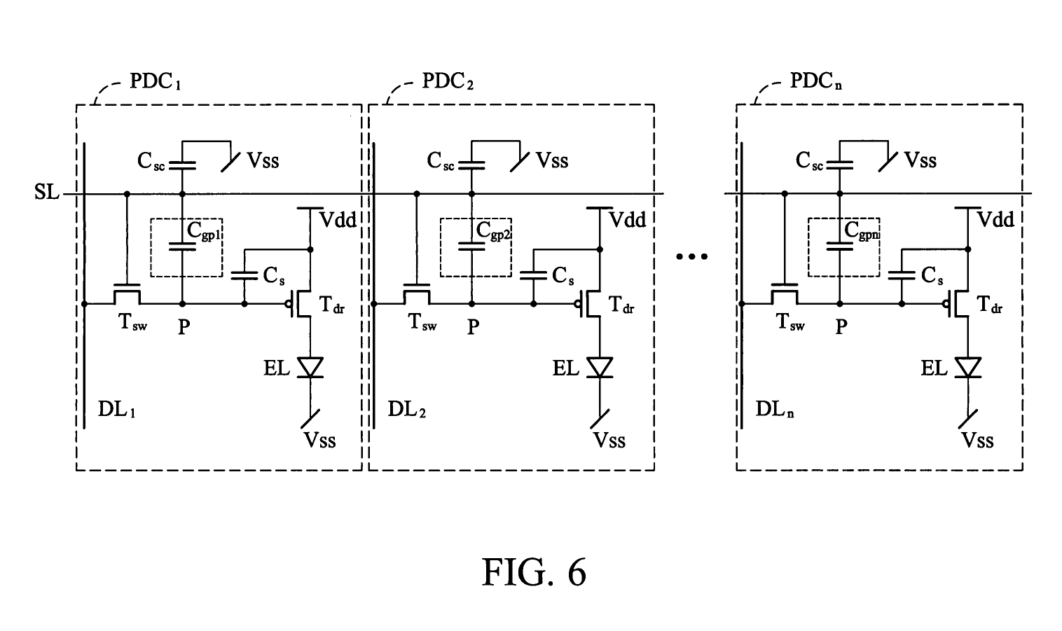

FIG. 6 is a schematic diagram of pixel driving circuits on the same row in a pixel array according to an embodiment of the invention. As shown in FIG. 6, the pixel array comprises a plurality of pixel driving circuits PDC₁, PDC₂, . . . , PDCₙ for an electroluminescent device. Each pixel driving circuit comprises a switch transistor T_{sw}, a scan line SL, a data line (respectively shown as DL₁, DL₂, . . . , DLₙ in FIG. 6), a driving transistor T_{dr}, an electroluminescent device EL, a storage capacitor C_{S} and a compensation capacitor (respectively shown as C_{gp1}, C_{gp2}, . . . , C_{gpn} in FIG. 6). The scan line SL is connected to a first terminal of the switch transistor T_{sw}. The data lines (respectively shown as DL₁, DL₂, . . . , DLₙ in FIG. 6) are respectively connected to a second terminal of the switch transistor T_{sw}. A first terminal of the driving transistor T_{dr} is connected to a third terminal of the switch transistor T_{sw}. A second terminal of the driving transistor T_{dr} is connected to a first potential. The electroluminescent device is connected between a third terminal of the driving transistor T_{dr} and a second potential. The storage capacitor Cₛ is connected between the first terminal of the driving transistor T_{dr} and the first potential, or a previous scan line (not shown in FIG. 6). The compensation capacitor (respectively shown as C_{gp1}, C_{gp2}, . . . , C_{gpn} in FIG. 6) is connected between the first terminals of the switch transistor T_{sw} and the driving transistor T_{dr}. Not all of the compensation capacitors connected to the same scan line have the same capacitance.

Preferably the switch transistor T_{sw} is an N-type thin film transistor and the driving transistor T_{dr} a P-type thin film transistor. Moreover, the first and second potentials are DC voltages. More specifically, the first potential is a power supply voltage Vdd and the second potential a ground Vss. In addition, the electroluminescent device EL is the embodiment is an OLED.

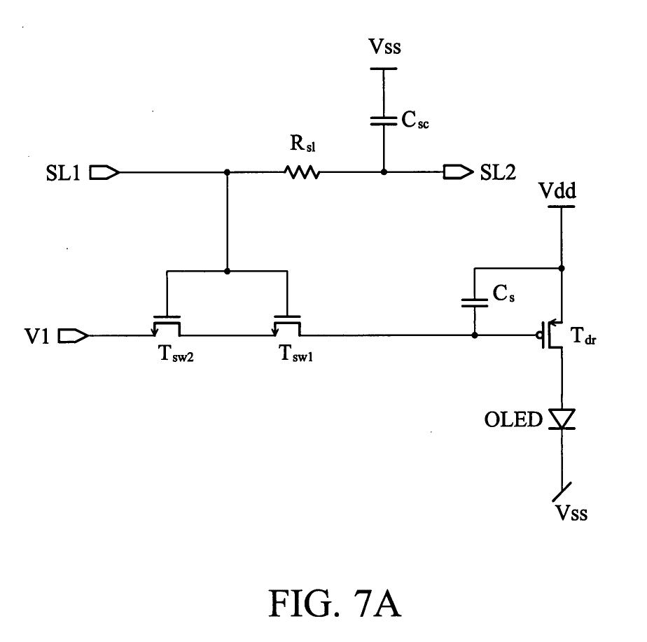

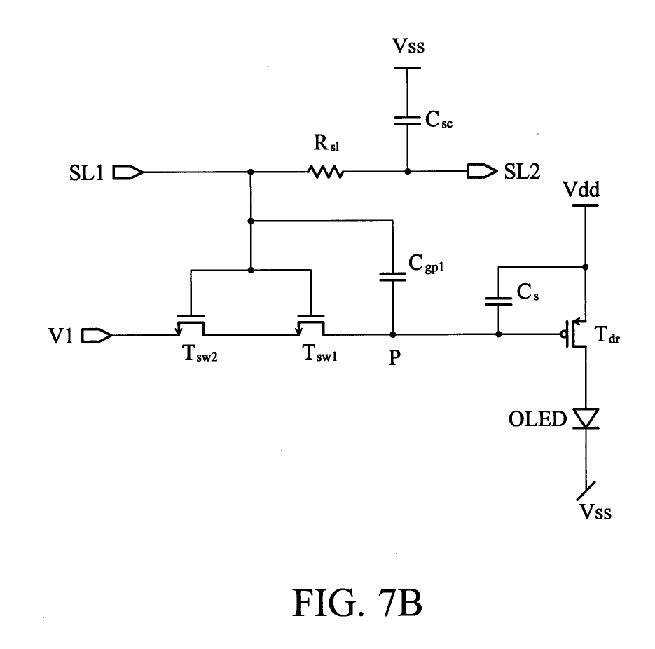

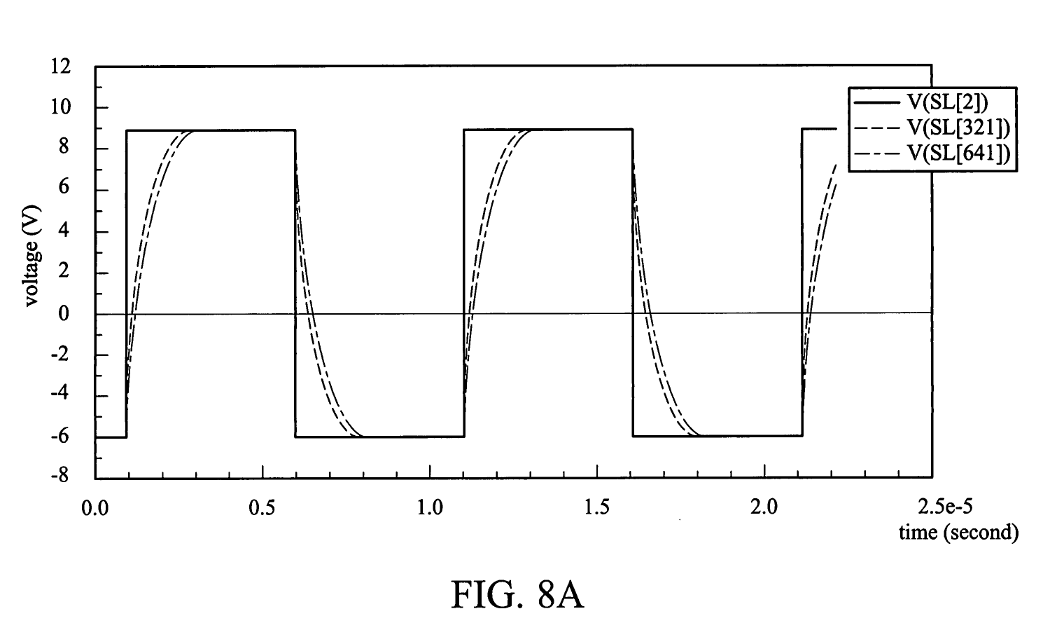

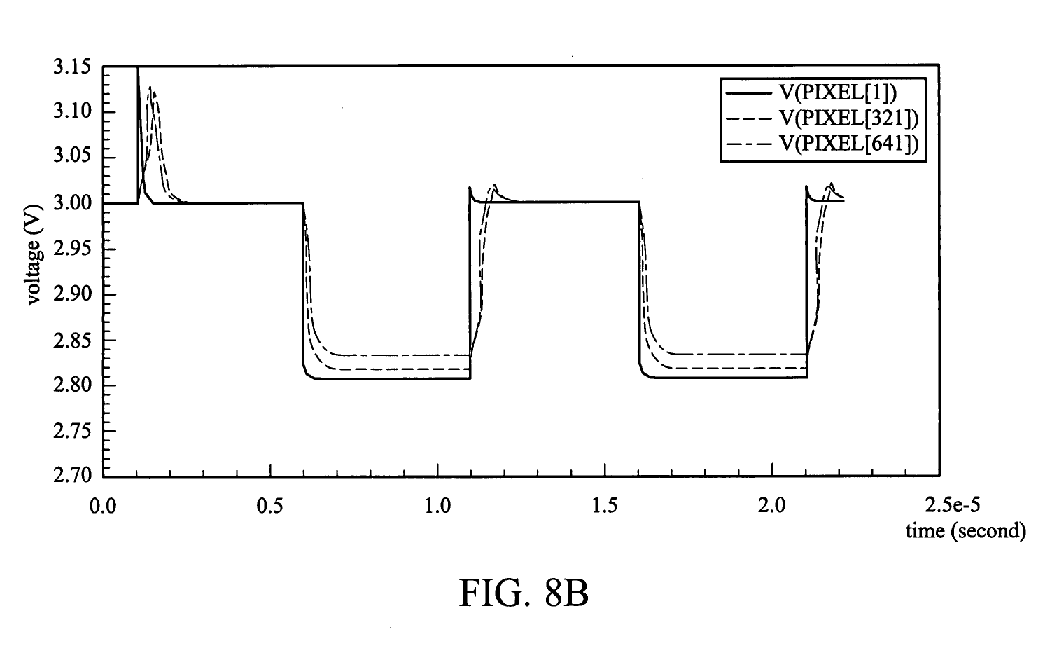

Simulation is performed to quantify effect of RC delay. A conventional pixel driving circuit used in the simulation is shown in FIG. 7A. Parasitic capacitance C_{sc} between a scan line of each pixel and Vss is 0.06 pF. Resistance Rₛₗ of the scan line in each pixel is 20 Ω. Capacitance Cₛ of a storage capacitor is 0.5 pF. Both channel width W and length L of the switch transistors T_{sw1} and T_{sw2} are 6 μm. High voltage level Vgh and low voltage level Vgl on the gate are respectively 9V and −6V. There are 640 pixels on the scan line in the simulation. The simulation results are shown in FIGS. 8A and 8B. The horizontal axis is time in second. The vertical axis is voltage in volt. FIG. 8A is a simulation diagram showing scan voltage on the scan line. It is noted that there is serious RC delay on the scan signal. FIG. 8B is a simulation diagram showing pixel voltage. It is found that the pixel voltage increases with distance from a gate driver.

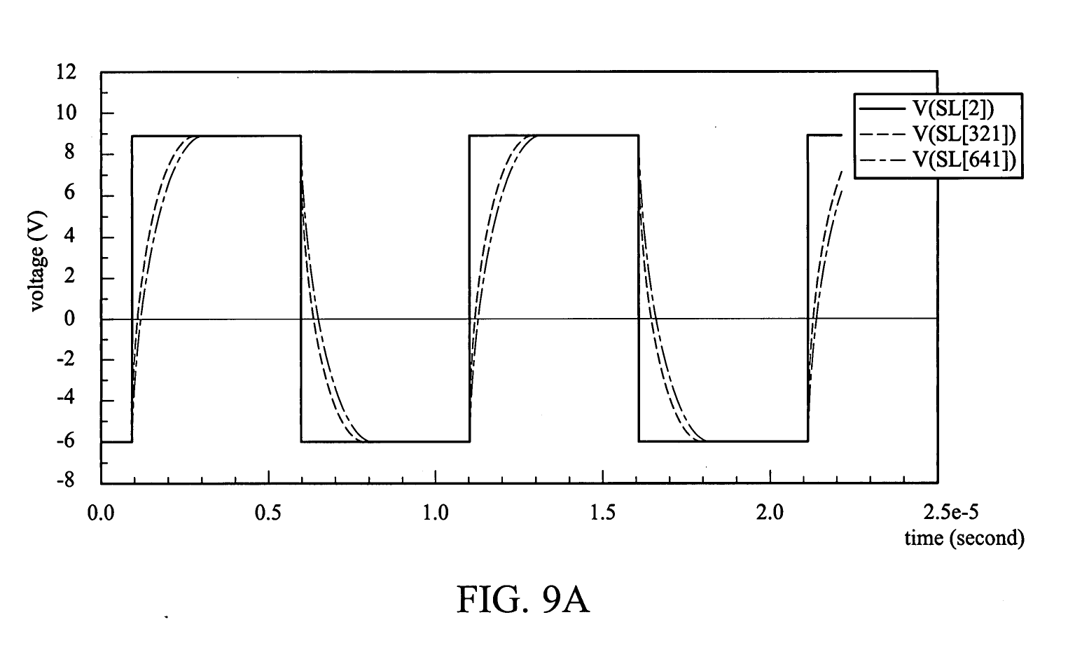

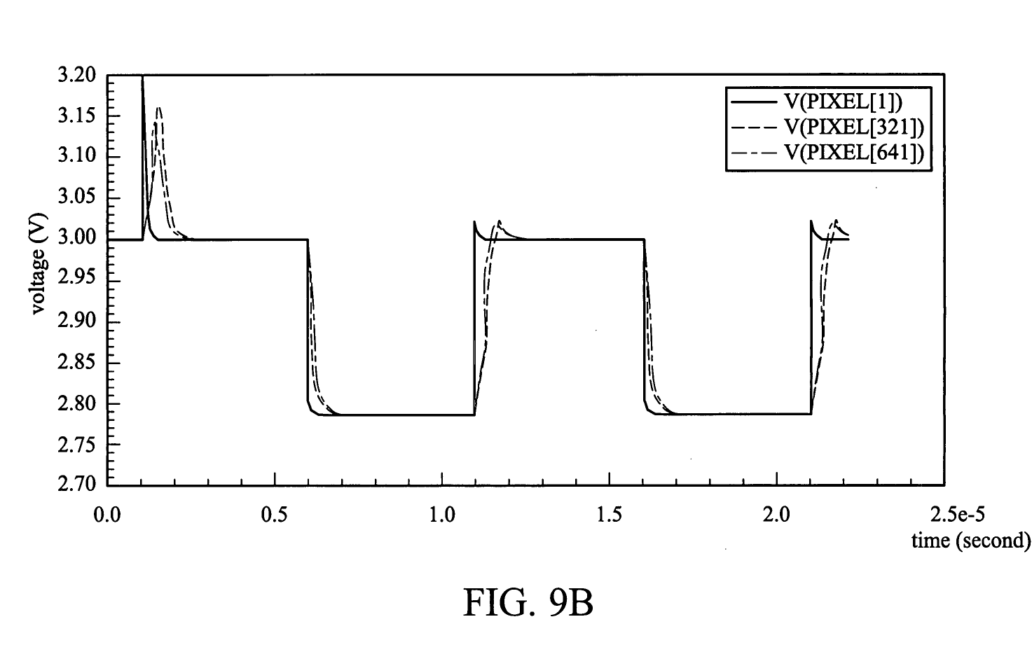

A pixel driving circuit according to an embodiment of the invention is shown as FIG. 7B. The additional compensation capacitor increases linearly with distance from a gate driver. The compensation capacitor C_{gp1} in the first pixel equals 2×10⁻¹⁷ F, the compensation capacitor C_{gp320} in the 320th pixel 320×2×10⁻¹⁷ F, and the compensation capacitor C_{gp640} in the 640th pixel 640×2×10⁻¹⁷ F. The simulation results are shown in FIGS. 9A and 9B. The horizontal axis is time in second. The vertical axis is voltage in volt. FIG. 9A is a simulation diagram showing scan voltage on the scan line. FIG. 9B is a simulation diagram showing pixel voltage. The pixel voltages of the 320th and 640th pixels are almost the same as the first pixel. Though the simulation is performed based on linear increase of compensation capacitor with pixel location, the scope of the invention is not limited thereto.

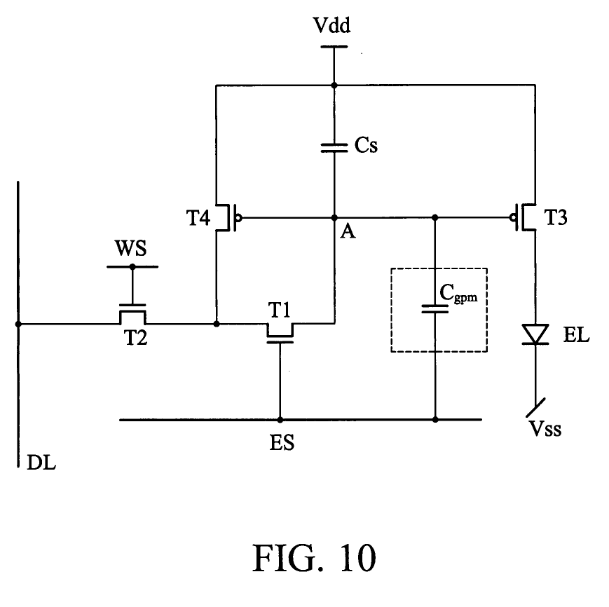

FIG. 10 is a circuit diagram of a pixel driving circuit in a pixel array according to another embodiment of the invention. As shown in FIG. 10, the pixel driving circuit comprises a first switch transistor T1, a second switch transistor T2, a first scan line ES for erase scan, a data line DL, a driving transistor T3, an electroluminescent device EL, a storage capacitor Cₛ and a compensation capacitor C_{gpm.} The first scan line ES is connected to a first terminal of the first switch transistor T1. The data line DL is connected to a second terminal of the first switch transistor T1 via the second switch transistor T2. A first terminal of the driving transistor T3 is connected to a third terminal of the first switch transistor T1. A second terminal of the driving transistor T3 is connected to a first potential. The electroluminescent device EL is connected between a third terminal of the driving transistor T3 and a second potential. The storage capacitor Cₛ is connected between the first terminal of the driving transistor T3 and the first potential, or a previous scan line (not shown in FIG. 10). The compensation capacitor C_{gpm} is connected between the first terminals of the first switch transistor T1 and the driving transistor T3. Not all compensation capacitors connected to the same scan line have the same capacitance. Preferably, the pixel driving circuit further comprises a second scan line WS for write scan connected to a gate of the second switch transistor T2.

The invention also provides a method of fabricating a pixel array, wherein pixels therein are current-driven. The method comprises forming a plurality of pixel driving circuits for an electroluminescent device and forming a compensation capacitor in each pixel driving circuit. As shown in FIG. 6, each pixel driving circuit comprises a switch transistor T_{sw}, a scan line SL, a data line (respectively shown as DL₁, DL₂, . . . , DLₙ in FIG. 6), a driving transistor T_{dr}, an electroluminescent device EL, and a storage capacitor Cₛ. The scan line SL is connected to a first terminal of the switch transistor T_{sw}. The data lines (respectively shown as DL₁, DL₂, . . . , DLₙ in FIG. 6) are respectively connected to a second terminal of the switch transistor T_{sw}. A first terminal of the driving transistor T_{dr} is connected to a third terminal of the switch transistor T_{sw}. A second terminal of the driving transistor T_{dr} is connected to a first potential. The electroluminescent device is connected between a third terminal of the driving transistor T_{dr} and a second potential. The storage capacitor Cₛ is connected between the first terminal of the driving transistor T_{dr} and the first potential, or a previous scan line (not shown in FIG. 6). Each compensation capacitor (respectively shown as C_{gp1}, C_{gp2}, . . . , C_{gpn} in FIG. 6) is connected between the first terminals of the switch transistor T_{sw} and the driving transistor T_{dr}. Not all compensation capacitors (respectively shown as C_{gp1}, C_{gp2}, . . . , C_{gpn} in FIG. 6) connected to the same scan line have the same capacitance.

In pixels on the same row, capacitors with different capacitances are added between terminals connected to variable potential and gates of switch transistors connected to the terminals. As a result, variation of pixel voltages due to RC delay can be minimized.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A pixel array, comprising:
a plurality of pixel driving circuits, each having:
a first switch transistor having first, second and third terminals;
a scan line coupled to the first terminal of the first switch transistor;
a data line coupled to the second terminal of the first switch transistor;
a driving transistor having first, second and third terminals, the first terminal of the driving transistor being coupled to the third terminal of the first switch transistor, the second terminal of the driving transistor being adapted to couple to a first voltage source;
an electroluminescent device having one end coupled to the third terminal of the driving transistor and another end adapted to couple to a second voltage source;
a storage capacitor having one end coupled to the first terminal of the driving transistor and another end coupled to the first voltage source; and
a compensation capacitor coupled between the first terminals of the first switch transistor and the driving transistor;
wherein at least two of the compensation capacitors connected to the same scan line have different capacitances.

2. The pixel array as claimed in claim 1, wherein the compensation capacitors have capacitances varying monotonically along the scan line.

3. The pixel array as claimed in claim 1, wherein the compensation capacitors have capacitances varying linearly along the scan line.

4. The pixel array as claimed in claim 1, wherein the scan line is configured to be driven by a gate driver, and capacitances of the compensation capacitors increase with distance from the gate driver.

5. The pixel array as claimed in claim 4, wherein the first voltage source is a Vdd power supply, and the second voltage source is ground.

6. The pixel array as claimed in claim 1, wherein the electroluminescent device comprises an OLED.

7. The pixel array as claimed in claim 1, wherein the data line is coupled to the second terminal of the first switch transistor via a second switch transistor in each pixel driving circuit.

8. The pixel array as claimed in claim 1, wherein each pixel driving circuit further comprises a second scan line coupled to the gate of the second switch transistor.

9. A display comprising the pixel array as claimed in claim 1.

10. A pixel array, comprising:
a plurality of pixel driving circuits, each having:
a first switch transistor having first, second and third terminals;
a scan line coupled to the first terminal of the first switch transistor;
a data line coupled to the second terminal of the first switch transistor;
a driving transistor having first, second and third terminals, the first terminal of the driving transistor being coupled to the third terminal of the first switch transistor, the second terminal of the driving transistor being adapted to couple to a first voltage source;
an electroluminescent device having one end coupled to the third terminal of the driving transistor and another end adapted to couple to a second voltage source;
a storage capacitor having one end coupled to the first terminal of the driving transistor and another end coupled to a previous scan line; and
a compensation capacitor coupled between the first terminals of the first switch transistor and the driving transistor;
wherein at least two of the compensation capacitors connected to the same scan line have different capacitances.

11. The pixel array as claimed in claim 10, wherein the compensation capacitors have capacitances varying monotonically along the scan line.

12. The pixel array as claimed in claim 10, wherein the compensation capacitors have capacitances varying linearly along the scan line.

13. The pixel array as claimed in claim 10, wherein the scan line is configured to be driven by a gate driver, and capacitances of the compensation capacitors increase with distance from the gate driver.

14. The pixel array as claimed in claim 13, wherein the first voltage source is a Vdd power supply, and the second voltage source is ground.

15. The pixel array as claimed in claim 10, wherein the electroluminescent device comprises an OLED.

16. The pixel array as claimed in claim 10, wherein the data line is coupled to the second terminal of the first switch transistor via a second switch transistor in each pixel driving circuit.

17. The pixel array as claimed in claim 10, wherein each pixel driving circuit further comprises a second scan line coupled to the gate of the second switch transistor.

18. A display comprising the pixel array as claimed in claim 10.

19. A method for fabricating a pixel array with a plurality of pixel driving circuits for an electroluminescent device, comprising:
forming a switch transistor having first, second and third terminals;
forming a scan line coupled to the first terminal of the switch transistor;
forming a data line coupled to the second terminal of the switch transistor;
forming a driving transistor having first, second and third terminals, the first terminal of the driving transistor coupled to the third terminal of the switch transistor, and the second terminal of the driving transistor coupled to a first voltage source;
forming an electroluminescent device having one end coupled to the third terminal of the driving transistor and another end adapted to couple to a second voltage source;
forming a storage capacitor having one end coupled to the first terminal of the driving transistor and another end coupled to the first voltage source; and
forming a compensation capacitor coupled between the first terminals of the switch transistor and the driving transistor, wherein at least two of the compensation capacitors connected to the same scan line have different capacitances.

20. The method as claimed in claim 19, wherein the step of forming a compensation capacitor in each pixel driving circuit comprises forming a compensation capacitor in each pixel driving circuit having monotonically varying capacitances of the compensation capacitors along the scan line.

21. The method as claimed in claim 19, wherein the step of forming a compensation capacitor in each pixel driving circuit comprises forming a compensation capacitor in each pixel driving circuit having linearly varying capacitances of the compensation capacitors along the scan line.

22. The method as claimed in claim 19, wherein the scan line is configured to be driven by a gate driver and the step of forming a compensation capacitor in each pixel driving circuit comprises forming a compensation capacitor in each pixel driving circuit having increasing capacitances of the compensation capacitors with distance from a gate driver.
